(19) United States
(12) Patent Application Publication
(10) Pub. No.: US 2024/0069647 A1
(43) Pub. Date: Feb. 29, 2024

(54) DETECTING METHOD, DETECTING DEVICE, AND RECORDING MEDIUM

(71) Applicant: CASIO COMPUTER CO., LTD., Tokyo (JP)

(72) Inventor: Akira INOUE, Tokyo (JP)

(73) Assignee: CASIO COMPUTER CO., LTD., Tokyo (JP)

(21) Appl. No.: 18/456,963

(22) Filed: Aug. 28, 2023

(30) Foreign Application Priority Data
Aug. 29, 2022 (JP) 2022-135471

(51) Int. Cl. G06F 3/01; G06V 10/56; G06V 40/20

(52) U.S. Cl. CPC G06F 3/017; G06V 10/56; G06V 40/28

(57) ABSTRACT

A detecting method executed by at least one processor includes acquiring a captured image that includes at least a part of an image display region on which an image is displayed and at least a part of a target object. The detecting method further includes detecting at least a part of the target object that is extracted in an external region as a detection target. The external region is in the captured image excluding the image display region.

### CROSS-REFERENCE TO RELATED APPLICATIONS

This application is based upon and claims the benefit of priority from the prior Japanese Patent Application No. 2022-135471, filed on Aug. 29, 2022, the entire contents of which are incorporated herein by reference.

### TECHNICAL FIELD

The present disclosure relates to a detecting method, a detecting device, and a recording medium.

### DESCRIPTION OF RELATED ART

Conventionally, there has been technology for detecting a gesture of an operator and controlling the operation of a device in response to the detected gesture. In this technology, a specific part (for example, a hand) of the operator's body that makes the gesture is detected as a detection target in an image of the operator. For example, a method of detecting the detection target performing the gesture based on the difference between a background image taken in advance and a captured image of the operator is disclosed.

### SUMMARY OF THE INVENTION

The detecting method according to the present disclosure is executed by at least one processor and includes:
acquiring a captured image that includes at least a part of an image display region on which an image is displayed and at least a part of a target object; and
detecting at least a part of the target object that is extracted in an external region as a detection target, the external region being in the captured image excluding the image display region.

The detecting device according to the present disclosure includes at least one processor that:
acquires a captured image that includes at least a part of an image display region on which an image is displayed and at least a part of a target object; and
detects at least a part of the target object that is extracted in an external region as a detection target, the external region being in the captured image excluding the image display region.

A non-transitory computer-readable recording medium according to the present disclosure stores a program that causes at least one processor to:
acquire a captured image that includes at least a part of an image display region on which an image is displayed and at least a part of a target object; and
detect at least a part of the target object that is extracted in an external region as a detection target, the external region being in the captured image excluding the image display region.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a schematic diagram of an information processing system;

FIG. 2 is a block diagram showing a functional structure of a detecting device;

FIG. 3 is a diagram illustrating an example of a captured image in which a projection image including a hand of a person is captured;

FIG. 4 is a flowchart showing a control procedure in a device control process;

FIG. 5 is a flowchart showing a control procedure in a hand detection process;

FIG. 6 is a diagram illustrating another example of a captured image; and

FIG. 7 is a flowchart showing an example of a captured image in a modification example.

### DETAILED DESCRIPTION

Hereinafter, one or more embodiments of the present invention will be described with reference to the drawings. However, the scope of the present invention is not limited to the disclosed embodiments.

<Summary of Information Processing System>

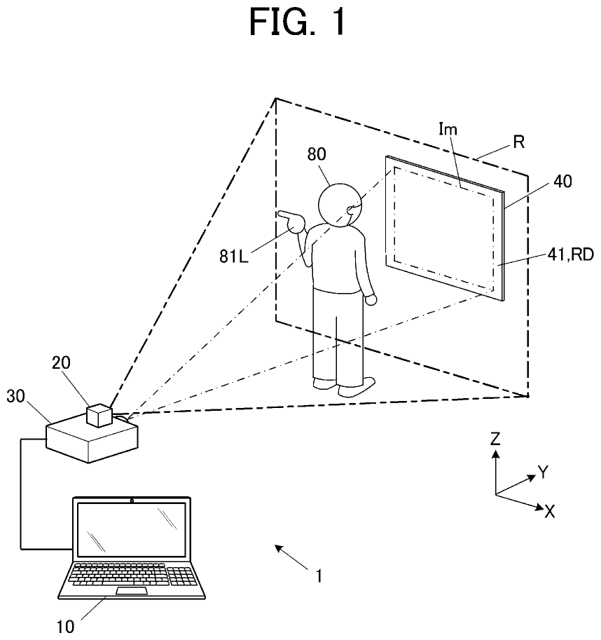

FIG. 1 is a schematic diagram of the information processing system 1 of the present embodiment.

The information processing system 1 includes a detecting device 10, an imaging device 20, and a projector 30. The detecting device 10 is connected to the imaging device 20 and the projector 30 by wireless or wired communication, and can send and receive control signals, image data, and other data to and from the imaging device 20 and the projector 30.

The detecting device 10 of the information processing system 1 is an information processing device that detects gestures made by an operator 80 (a subject, a person) with a hand(s) 81 (a target, a detection target) and controls the operation of the projector 30 (operation to project a projection image Im, operation to change various settings, and the like) depending on the detected gestures. The “hand 81” in the present application can be either the right hand 81R or the left hand 81L of the operator 80.

In detail, the imaging device 20 takes an image of the operator 80 located in front of the imaging device 20 and the hand 81 of the operator 80, and sends image data of the captured image 50 (see FIG. 3) to the detecting device 10. The detecting device 10 analyzes the captured image 50 from the imaging device 20, detects the hand 81 and a finger(s) of the operator 80, and determines whether or not the operator 80 has made the predetermined gesture with the hand 81. In the present embodiment, the gesture made by the operator 80 with the hand 81 is defined as a gesture including an orientation or movement of the finger(s) of the hand(s) 81. When the detecting device 10 determines that the operator 80 has made a predetermined gesture with the hand 81, it sends a control signal to the projector 30 and controls the projector 30 to perform an action in response to the detected gesture. This allows the operator 80 to intuitively perform an operation of switching the projection image Im being projected by the projector 30 to the next projection image Im by, for example, making a gesture with one finger (for example, an index finger) pointing to the right as viewed from the imaging device, and an operation of switching the projection image Im being projected to the previous projection image Im by making a gesture with the one finger pointing to the left.

In the present embodiment, a screen 40 is hung on a wall, and the projector 30 projects (displays) a projection image Im on the image display surface 41 of the screen 40. The image display surface 41 is the side facing the imaging device 20 of the front and back surfaces of the screen 40. In the present embodiment, the region occupied by the image display surface 41 constitutes the image display region RD in which the projection image Im is projected (displayed). The screen 40 corresponds to “a component constituting the image display region. In the following, the Z axis is perpendicular to the floor on which the operator 80 is standing. The +Z direction is the direction along the Z axis and vertically upward. The Y axis is parallel to the floor surface and parallel to the direction of projection by the projector 30 as viewed from the +Z direction. The X axis is perpendicular to the Y and Z axes. The +Y direction is the direction along the Y axis from the projector 30 toward the operator 80. The +X direction is the direction to the right along the X axis, as viewed from the projector 30 toward the operator 80.

In the present embodiment, the operator 80 stands in front of the screen 40 (at a position on the image display surface 41 side (−Y direction side) of the screen 40) and looks at the projection image Im projected on the screen 40. The operator 80 makes a gesture with the left hand 81L to operate the projector 30. The imaging region R captured by the imaging device 20 includes the image display surface 41 of the screen 40 and at least the upper body of the operator 80.

<Configuration of Information Processing System>

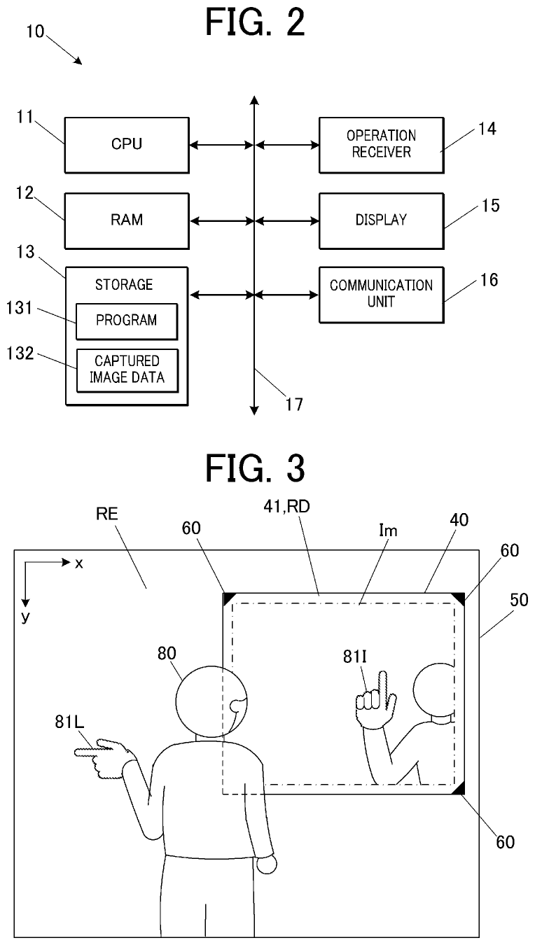

FIG. 2 is a block diagram showing the functional configuration of the detecting device 10.

The detecting device 10 includes a CPU 11 (Central Processing Unit), a RAM 12 (Random Access Memory), a storage 13 (a recording medium), an operation receiver 14, a display 15, a communication unit 16, and a bus 17. The parts of the detecting device 10 are connected to each other via the bus 17. The detecting device 10 is a notebook personal computer in the present embodiment, but may be, for example, a stationary personal computer, a smartphone, or a tablet device.

The CPU 11 is a processor that controls the operation of the detecting device 10 by reading and executing the program 131 stored in the storage 13 and performing various arithmetic operations. The CPU 11 corresponds to “at least one processor”. The detecting device 10 may have multiple processors (i.e., multiple CPUs), and the multiple processes performed by the CPU 11 in the present embodiment may be performed by the multiple processors. In this case, the multiple processors correspond the “at least one processor”. In this case, the multiple processors may be involved in a common process, or may independently perform different processes in parallel.

The RAM 12 provides the CPU 11 with memory space for work and stores temporary data.

The storage 13 is a non-transitory recording medium that can be read by the CPU 11 as a computer and stores the program 131 and various data. The storage 13 includes a non-volatile memory, such as a hard disk drive (HDD) and a solid-state drive (SSD). The program 131 is stored in the storage 13 in the form of computer-readable program code. The storage 13 stores captured image data 132 relating to a color image and a depth image, etc., received from the imaging device 20 as data.

The operation receiver 14 has at least one of a touch panel superimposed on the display screen of the display 15, a physical button, a pointing device such as a mouse, and an input device such as a keyboard. The operation receiver 14 outputs operation information to the CPU 11 in response to input operations on the input device.

The display 15 includes a display device such as a liquid crystal display and causes the display device to display various items according to display control signals from the CPU 11.

The communication unit 16 is configured with a network card, communication module, or the like, and transmits data between the imaging device 20 and the projector 30 in accordance with a predetermined communication standard.

The imaging device 20 illustrated in FIG. 1 includes a color camera.

The color camera captures an imaging region R including the image display region RD of the screen 40, the operator 80, and their background, and generates color image data related to a two-dimensional color image of the imaging region R. The color image data includes color information of each pixel such as R (red), G (green), and B (blue). The color camera of the imaging device 20 takes a series of images of the operator 80 and the screen 40 positioned in front of the imaging device 20 at a predetermined frame rate.

The color image data generated by the color camera is stored in the storage 13 of the detecting device 10 as the captured image data 132 (see FIG. 2).

In the present embodiment, the above color image corresponds to the “captured image acquired by capturing the imaging region”.

The projector 30 illustrated in FIG. 1 projects the projection image Im on the image display surface 41 (that is, the image display region RD) of the screen 40 by emitting a highly directional projection light with an intensity distribution corresponding to the image data of the projection image Im. In detail, the projector 30 includes a light source, a display element such as a digital micromirror device (DMD) that adjusts the intensity distribution of light output from the light source to form a light image, and a group of projection lenses that focus the light image formed by the display element and project it as the projection image Im. The projector 30 changes the projection image Im to be projected or changes the settings (brightness, hue, and the like) related to the projection mode according to the control signal sent from the detecting device 10.

<Operation of Information Processing System>

The operation of the information processing system 1 is described next.

The CPU 11 of the imaging device 10 analyzes one or more captured images 50 captured by the imaging device 20 to determine whether or not the operator 80 captured in the captured images 50 has made a predetermined gesture with the hand 81. When the CPU 11 determines that the gesture has been made with the hand 81, it sends a control signal to the projector 30 to cause the projector 30 to perform an action in response to the detected gesture.

The gesture with the hand 81 is, for example, moving the finger in a certain direction (rightward, leftward, downward, upward, or the like) as viewed from the imaging device 20, moving the fingertip to draw a predetermined shape trajectory (circular or the like), changing the distance between tips of two or more fingers, bending and stretching of the finger(s), or the like. Each of these gestures is mapped to one action of the projector 30 in advance. For example, a gesture of turning the finger to the right may be mapped to an action of switching the current projection image Im to the next projection image Im, and a gesture of turning the finger to the left may be mapped to an action of switching the current projection image Im to the previous projection image Im. In this case, the projection image can be switched to the next/previous projection image by making a gesture of turning the finger to the right/left. The gesture of increasing/decreasing the distance between the tips of the thumb and index finger may be mapped to the action of enlarging/reducing the projection image Im, respectively. These are examples of mapping a gesture to an action of the projector 30, and any gesture can be mapped to any action of the projector 30. In response to user operation on the operation receiver 14, it may also be possible to change the mapping or to generate a new mapping between the gesture and the action of the projector 30.

When the operator 80 operates the projector 30 with the gesture of the hand 81, it is important to correctly detect the hand 81 in the image captured by the imaging device 20. This is because when the hand 81 cannot be detected correctly, the gesture cannot be recognized correctly, and operability will be severely degraded.

However, when the imaging region R captured by the imaging device 20 includes the image display region RD of the screen 40, a projection image Im including a hand 811 of a person may be projected in the image display region RD.

FIG. 3 is a diagram illustrating an example of a captured image 50 in which a projection image Im including a hand 811 of a person is captured.

The x-axis and y-axis illustrated in FIG. 3 are the coordinate axes of an orthogonal coordinate system that represent the positions of the pixels in the captured image 50.

When the captured image 50 includes the projection image Im and the projection image Im includes a person hand 811 as illustrated in FIG. 3, the hand 81 in the projection image Im may be erroneously detected as a detection target. Due to the erroneous detection of the gesture that occurs in response to the erroneous detection of the hand 81 in the projection image Im, the projector 30 performs an unintended action.

Therefore, in the present embodiment, based on the positional relationship between the hand 81 of the operator 80 and the image display region RD of the screen 40, the hand 81 in the projection image Im that is not making a gesture is removed from the detection target, and the hand 81 of the operator 80 that is making a gesture is detected appropriately as the detection target.

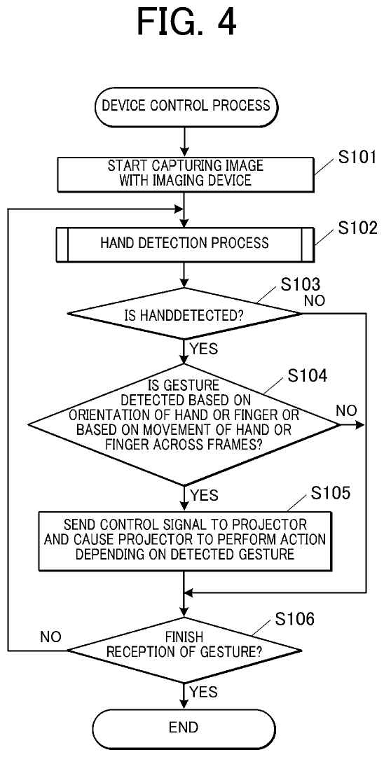

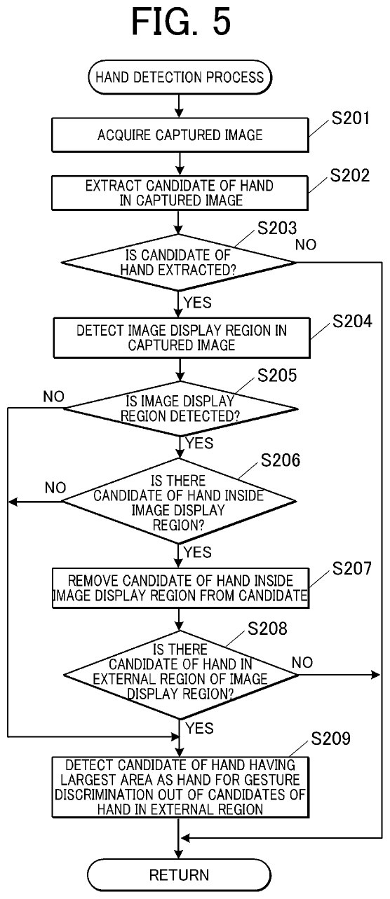

Referring to FIG. 4 and FIG. 5, the operation of the CPU 11 of the detecting device 10 to detect the hand 81 of the operator 80 and to detect a gesture with the hand 81 to control the action of the projector 30 are described below. The CPU 11 executes the device control process illustrated in FIG. 4 and the hand detection process illustrated in FIG. 4 and FIG. 5 to achieve the above actions.

FIG. 4 is a flowchart showing a control procedure in a device control process.

The device control process is executed, for example, when the detecting device 10, the imaging device 20, and the projector 30 are turned on and a gesture to operate the projector 30 is started to be received.

When the device control process is started, the CPU 11 sends a control signal to the imaging device 20 to cause the color camera to start capturing an image (Step S101). When an image is started to be captured, the CPU 11 executes the hand detection process (Step S102).

FIG. 5 is a flowchart showing the control procedure in the hand detection process.

When the hand detection process is started, the CPU 11 acquires the captured image 50 (the captured image data 132) of the operator 80 and the hand 81 (Step S201). The CPU 11 extracts a candidate of the hand region corresponding to the hand 81 (hereinafter simply referred to as a “candidate of the hand 81”) in the acquired captured image 50 (Step S202). The process of extracting the candidate of the hand 81 in the captured image 50 corresponds to the process of extracting the target object in the captured image 50.

In the captured image 50 illustrated in FIG. 3, the operator 80 standing in front of the screen 40 is making a gesture of pointing the index finger of his left hand 81L toward the left (in the −x direction). The person captured in the projection image Im is pointing the index finger of his hand 811 upward (in the −y direction). Therefore, when the captured image 50 illustrated in FIG. 3 is acquired, the CPU 11 extracts the left hand 81L of the operator 80 and the hand 811 in the projection image Im as candidates of the hand 81 in Step S202.

The method of extracting a candidate of the hand 81 from the captured image 50 in Step S202 is not particularly limited, but may be, for example, the following method. First, a thresholding process related to color is performed based on the color information of the color image to extract a skin color (the color of the hand 81) region(s) from the color image. Next, whether or not the extracted region each has a protrusion(s) corresponding to a finger(s) is determined. Of the extracted regions, the region(s) determined to have the protrusion corresponding to the finger is extracted as a candidate(s) of the hand 81.

The CPU 11 may generate a mask image representing the hand region corresponding to the extracted hand 81 and use the mask image data in subsequent processes. The mask image data is, for example, an image in which the pixel values of the pixels corresponding to the hand region are set to “1” and the pixel values of the pixels corresponding to the areas other than the hand region are set to “0”.

The CPU 11 determines whether or not a candidate of the hand 81 has been extracted in Step S202 (Step S203). If it is determined that a candidate of the hand 81 has been extracted (“YES” in Step S203), the CPU 11 detects (identifies) the image display region RD of the screen 40 in the captured image 50 (Step S204).

As illustrated in FIG. 3, the screen 40 of the present embodiment is provided with right-angled isosceles triangle sign(s) 60 at the (four) corner(s) of the image display surface 41. The signs 60 represent the four corners of the screen 40. Thus, when the signs 60 are provided at predetermined positions in the screen 40, the CPU 11 can detect the image display region RD based on the positions of the signs 60 in the captured image 50. In the example illustrated in FIG. 3, the CPU 11 identifies the positions of the vertices of the right angles of the signs 60 and identifies a rectangular region representing the image display region RD based on the positions of the vertices of at least three of the signs 60. The shapes of the signs 60 and the positions of the signs 60 on the screen 40 are not limited to those illustrated in FIG. 3.

The method of identifying the image display region RD from the captured image 50 is not limited to the method using the signs 60 on the screen 40.

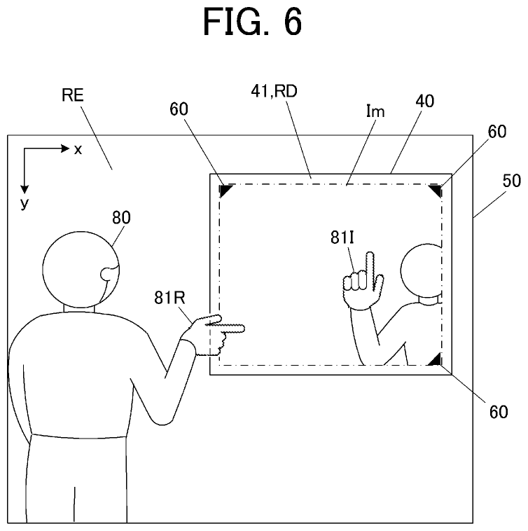

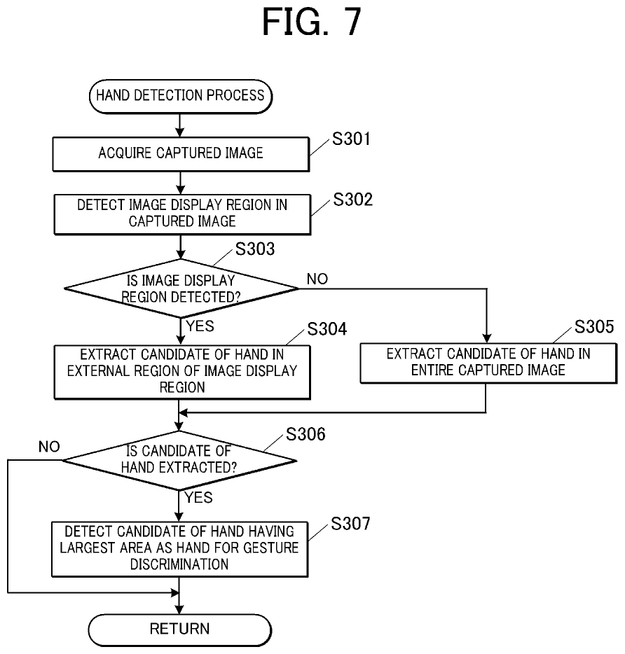

For example, as illustrated in FIG. 6, a projection image Im including signs 60 at predetermined positions (for example, at the four corners) may be projected onto the image display region RD, and the image display region RD may be detected based on the positions of the signs 60 in the captured image 50. This allows accurate detection of the range of the projection image Im based on the positions of the signs 60, as well as the detection of the image display region RD. Since this method enables accurate detection of the range of the projection image Im, the range of the projection image Im may be used as the image display region RD instead of the image display surface 41 of the screen 40. The projection image Im may be projected using image data of the projection image Im including data of signs 60, so that the signs 60 may be provided in the projection image Im. Alternatively, in transmission of image data of the projection image Im from the detecting device 10 to the projector 30, the data of the signs 60 may be added to the image data, and the image data to which the data of the signs 60 is added may be used to project the projection image Im so that the signs 60 may be provided in the projection image Im.

Alternatively, when there is a boundary line that forms a rectangle of the extracted boundary lines between objects in the captured image 50, the image display region RD may be identified based on the positions of the vertices of the rectangle.

Alternatively, when the positional relationship between the imaging device 20 and the screen 40 is fixed, the range of the image display region RD in the captured image 50 may be identified in advance based on the positional relationship. In other words, calibration may be performed to identify the range of the image display region RD in advance.

The CPU 11 determines whether or not the image display region RD has been detected (Step S205). If it is determined that the image display region RD has been detected (“YES” in Step S205), the CPU 11 determines whether or not there is a candidate(s) of the hand 81 inside the image display region RD (Step S206). Here, the CPU 11 determines a hand 81 whose entire region is inside the image display region RD to be a candidate of the hand 81 inside the image display region RD. When the region of the hand 81 extends from inside to outside of the image display region RD (across the outline of the image display region RD) in the captured image 50 like the right hand 81R of the operator 80 illustrated in FIG. 6, the CPU 11 determines that the hand 81 is outside of the image display region RD. This is because the hand 81 extending from inside to outside the image display region RD cannot be the hand 811 that is displayed in the image display region RD, but may be the hand 81 of the operator 80 who is making the gesture.

If it is determined that there is a candidate of the hand 81 inside the image display region RD (“YES” in Step S206), the CPU 11 removes the candidate of the hand 81 inside the image display region RD from the candidate of the detection target (Step S207).

The CPU 11 determines whether or not there is a candidate(s) of the hand 81 in an external region RE of the captured image 50 excluding the image display region RD (Step S208). If it is determined that there is a candidate of the hand 81 in an external region RE (“Yes” in Step S208), the CPU 11 detects the candidate of the hand 81 having the largest area of the candidate(s) of the hand 81 in the external area RE as the hand 81 (detection target) for gesture discrimination (Step S209).

If it is determined that the image display region RD has not been detected in Step S205 (“YES” in Step S205) or if it is determined that there is no candidate of the hand 81 inside the image display region RD (“NO” in Step S206), the candidate of the hand 81 is in the external region RE. Therefore, the CPU 11 moves the process to Step S209 and detects the candidate of the hand 81 having the largest area of the candidates of the hand 81 in the external region RE as the hand 81 (detection target) for gesture discrimination. If no image display region RD is detected in the captured image 50, the entire captured image 50 is assumed to correspond to the external region RE.

If the process of Step S209 is completed, the CPU 11 finishes the hand detection process and returns the process to the device control process in FIG. 4.

If it is determined that no candidate of the hand 81 has been extracted in Step S203 (“NO” in Step S203), or if it is determined that there is no candidate of the hand 81 in the external region RE in Step S208 (“Yes” in Step S208), the CPU 11 does not detect the hand 81 for gesture discrimination, finishes the hand detection process, and returns the process to the device control process in FIG. 4.

The CPU 11 detects the candidate of the hand 81 having the largest area as the hand 81 for gesture discrimination in above Step S209, but may determine the one hand 81 for gesture discrimination in other ways. For example, the CPU 11 may derive an index value representing the possibility that the candidate is a hand 81 based on the shape of the fingers of the hand 81, etc., and detect the candidate of the hand 81 having the largest index value as the hand 81 for gesture discrimination.

The order of the processes is not limited to that in the flowchart in FIG. 5, where the candidate of the hand 81 is extracted first (Step S202), and then the image display region RD is detected (Step S204). The image display region RD may be detected first, and then the candidate of the hand 81 may be extracted.

When the hand detection process of Step S102 in FIG. 4 is completed, the CPU 11 determines whether or not the hand 81 for gesture discrimination has been detected in the hand detection process (Step S103). If it is determined that a hand 81 has been detected (“YES” in Step S103), the CPU 11 determines whether or not a gesture with the hand 81 of the operator 80 has been detected based on the orientation of the finger(s) of the hand 81 or the movement of the fingertip position across the multiple frames of the captured image 50 (Step S104). If it is determined that a gesture has been detected (“YES” in Step S104), the CPU 11 sends a control signal to the projector 30 to cause it to perform an action in response to the detected gesture (Step S105). The projector 30 having received the control signal performs the action in response to the control signal.

If the process of Step S105 is completed, if it is determined in Step S103 that no hand 81 has been detected (“NO” in Step S103), or if it is determined in Step S104 that no gesture has been detected (“NO” in Step S104), the CPU 11 determines whether or not to finish receiving the gesture in the information processing system 1 (Step S106). Here, the CPU 11 determines to finish receiving the gesture when, for example, an operation to turn off the power of the device 10, the imaging device 20, or the projector 30 is performed.

If it is determined that the receiving the gesture is not finished (“NO” in Step S106), the CPU 11 returns the process to Step S102 and executes the hand detection process to detect the hand 81 based on the captured image captured in the next frame period. A series of looping processes of Steps S102 to S106 is repeated, for example, at the frame rate of the capture with the imaging device 20 (that is, each time the captured image 50 is generated).

If it is determined that the receiving of the gesture is finished (“YES” in Step S106), the CPU 11 finishes the device control process.

### Modification Example

Next, a modification example of the above embodiment will be described. In this modification example, the control procedure in the hand detection process differs from that in the above embodiment. In the following, differences from the above embodiment will be described. Configurations that are common to the above embodiment will be labeled with common reference signs and omitted in the following description.

FIG. 9 is a flowchart showing the control procedure in the hand detection process according to the modification example.

In the hand detection process in the modification example, the image display region RD is detected (identified) first, and then the candidate of the hand 81 is extracted in the external region RE outside of the image display region RD. This procedure allows the hand 81 inside the image display region RD, which is finally removed from the candidates, not to be extracted in the first place.

Upon start of the hand detection process according to this modification example, the CPU 11 acquires the captured image 50 (captured image data 132) of the operator 80 and the hand 81 (Step S301).

The CPU 11 detects (identifies) the image display region RD of the screen 40 in the captured image 50 (Step S302). The process of Step S302 is the same as that of Step S204 in FIG. 5.

The CPU 11 determines whether or not the image display region RD has been detected (Step S303). If it is determined that the image display region RD has been detected (“YES” in Step S303), the CPU 11 extracts a candidate of the hand 81 in the external region RE outside of the image display region RD (Step S304). The process of Step S304 is the same as that of Step S202 in FIG. 5, except that the range to be extracted is the external region RE.

If it is determined that no image display region RD has been detected (“NO” in Step S303), the CPU 11 extracts a candidate of the hand 81 in the entire captured image 50 (Step S305). The process of Step S305 is the same as that of Step S202 in FIG. 5.

When the process of Step S304 or Step S305 is completed, the CPU 11 determines whether or not a candidate of the hand 81 has been extracted (Step S306). If it is determined that a candidate of the hand 81 has been extracted (“YES” in Step S306), the CPU 11 detects the candidate of the hand 81 having the largest area of the extracted candidate(s) of the hand 81 as the hand 81 (detection target) for gesture discrimination (Step S307). Therefore, if a candidate(s) of the hand 81 in the external region RE has been extracted in Step S304, the hand 81 for gesture discrimination is detected of the candidate(s) of the hand 81 extracted in the external region RE.

If the process of Step S209 is completed, the CPU 11 finishes the hand detection process and returns the process to the device control process in FIG. 4.

If it is determined that no candidate of the hand 81 has been extracted (“NO” in Step S306), the CPU 11 finishes the hand detection process without detecting the hand 81 for gesture discrimination and returns the process to the device control process in FIG. 4.

<Effects>

As described above, the detecting method of the present embodiment is executed by the CPU 11 and includes: acquiring a captured image 50 that includes at least a part of the image display region RD on which the projection image Im is displayed and at least a part of the hand 81 (the target object) of the operator 80; and detecting at least a part of the hand 81 that is extracted in the external region RE as a detection target. The external region is in the captured image excluding the image display region. As a result, even when a projection image Im including a hand 811 of a person is displayed in the image display region RD captured in the captured image 50, the hand(s) 811 is removed from the detection target, such that the hand 81 of the operator 80 making the gesture can be appropriately detected as the detection target.

Further, when the detecting method includes identification of the image display region RD in the captured image 50 and detection of at least a part of the hand 81 extracted in the external region RE that is in the captured image 50 excluding the identified image display region RD as the detection target. As a result, it is possible to remove the hand 81 captured in the image display region RD from the detection target.

Further, the detecting method include identifying the image display region RD in the captured image 50; extracting the hand 81 in the captured image 50; and determining whether or not the extracted hand 81 is in the external region RE that is in the captured image 50 excluding the image display region RD, and detecting at least a part of the hand 81 that is determined to be in the external region RE as the detection target. Thus, by extracting the candidate of the hand 81 in the entire captured image 50 first and then determining whether or not the hand 81 is in the external region RE, it is less likely that the hand 81 of the operator 80 making the gesture will be omitted from detection.

Further, the detecting method according to the modification example includes identifying the image display region RD in the captured image 50; extracting the hand 81 in the external region RE that is in the captured image 50 excluding the identified image display region RD; and detecting at least a part of the extracted hand 81 as the detection target. As a result, even when a projection image Im including a hand 811 of a person is displayed in the image display region RD captured in the captured image 50, the hand 811 is removed from the detection target, such that the hand 81 of the operator 80 making a gesture can be appropriately detected as the detection target. Also, it is possible not to extract the hand 81 inside the image display region RD, which is to be finally removed from the candidates, in the first place. Therefore, the process of extracting the hand 81 inside the image display region RD and the process of removing the hand 81 extracted inside the image display region RD from the candidates can be omitted, and thus the processing load of the CPU 11 can be reduced.

Further, upon extraction of multiple hands 81, a hand 81 having the largest area of the multiple hands 81 is detected as the detection target. As a result, the hand 81 that is likely to be the hand 81 of the operator 80 making the gesture can be appropriately detected as the detection target of the multiple hands 81.

Further, when the extracted hand 81 extends from inside to outside of the image display region RD in the captured image 50, the hand 81 is determined to be outside of the image display region RD. The hand 81 extending from inside to outside of the image display region RD cannot be the hand 811 displayed in the image display region RD, but may be the hand 81 of the operator 80 who is making the gesture. Therefore, by determining that such a hand 81 is outside the image display region RD, the hand 81 can be appropriately detected as the detection target.

Further, the screen 40 constituting the image display region RD is provided with the sign(s) 60 at a predetermined position(s), and the image display region RD is identified based on the position of the sign 60 in the captured image 50. This allows the image display region RD to be easily identified based on the captured image 50 that does not include depth information.

Further, the projection image Im displayed on the image display region RD may include the sign(s) 60 at a predetermined position(s), and the image display region RD may be identified based on the position of the sign 60 in the captured image 50. This allows the image display region RD to be easily identified based on the captured image 50 that does not include depth information. The range of the projection image Im that can be accurately detected from the position(s) of the sign(s) 60 can also be regarded as the image display region RD. Therefore, when the projection image Im is small compared to the screen 40, the area of the screen 40 where the projection image Im is not projected can be treated as an external region RE of the image display region RD. When the hand 81 of the operator 80 is projected in the external region RE, the hand 81 can be appropriately detected as the detection target.

The detecting device 10 according to the present embodiment includes the CPU 11 that acquires the captured image 50 that includes at least a part of the image display region RD on which the projection image Im is displayed and at least a part of the hand 81 (target object) of the operator 80, and that detects at least a part of the hand 81 that is extracted in the external region RE that is in the captured image 50 excluding the image display region RD as a detection target. As a result, even when a projection image Im including a hand 811 of a person is displayed in the image display region RD captured in the captured image 50, the hand(s) 811 is removed from the detection target, such that the hand 81 of the operator 80 making the gesture can be appropriately detected as the detection target.

The storage 13 according to the present embodiment is a non-transitory computer-readable recording medium that stores the program 131 that can be executed by the CPU 11. The program 131 causes the CPU 11 to acquire a captured image 50 that includes at least a part of an image display region RD on which the projection image Im is displayed and at least a part of the hand 81 (the target object) of the operator 80; and detect at least a part of the hand 81 that is extracted in the external region RE that is in the captured image 50 excluding the image display region RD as the detection target. As a result, even when a projection image Im including a hand 811 of a person is displayed in the image display region RD captured in the captured image 50, the hand(s) 811 is removed from the detection target, such that the hand 81 of the operator 80 making the gesture can be appropriately detected as the detection target.

<Others>

The detecting method, the detecting device, and the program related to the present disclosure are exemplified in the description of the above embodiment, but are not limited thereto.

For example, the above embodiment is explained using an example in which the detecting device 10, the imaging device 20, and the projector 30 (the device to be operated by gestures) are separate, but this does not limit the present disclosure.

For example, the detecting device 10 and the imaging device 20 may be integrated into a single unit. As a specific example, the color camera of the imaging device 20 may be housed in a bezel of the display 15 of the detecting device 10.

Alternatively, the detecting device 10 and the device to be operated may be integrated into a single unit. For example, the functions of the detecting device 10 may be incorporated into the projector 30 in the above embodiment, and the processes performed by the detecting device 10 may be performed by a CPU (not shown in the drawings) of the projector 30. In this case, the projector 30 corresponds to the “detecting device”, and the CPU of the projector 30 corresponds to the “at least one processor”.

Alternatively, the imaging device 20 and the device to be operated may be integrated into a single unit. For example, the color camera of the imaging device 20 may be incorporated into the housing of the projector 30 in the above embodiment.

Alternatively, the detecting device 10, the imaging device 20, and the device to be operated may all be integrated into a single unit. For example, the color camera is housed in the bezel of the display 15 of the detecting device 10 as the device to be operated, and the detecting device 10 may be configured such that its actions are controlled by gestures made by the operator 80 with the hand 81 (finger).

The operator 80 is not limited to a person, but can also be a robot, an animal, or the like.

In the above embodiment, the gesture made by the operator 80 with the hand 81 is a gesture including orientation or movement of the finger(s) of the hand(s) 81, but is not limited to this. The gesture made by the operator 80 with the hand 81 may be, for example, a gesture made by the movement of the entire hand 81. The gesture of touching the image display surface 41 with a fingertip may also be used.

The imaging device 20 may have a depth camera in addition to the color camera. The depth camera captures the imaging region R including the image display region RD of the screen 40, the operator 80, and their background, and generates depth image data related to a depth image including depth information of the imaging region R. Each pixel in the depth image includes depth information related to the depth (distance from the depth camera to a measured object) of the image display region RD, the operator 80, and a background structure(s) (collectively referred to as the “measured object”). The depth camera can be, for example, one that detects distance using the TOF (Time of Flight) method, or one that detects distance using the stereo method. When the imaging device 20 includes the color camera and the depth camera, the image display surface 41, that is, the image display region RD, may be identified based on the depth information in the depth image. For example, a planar rectangular region with a continuously changing depth in the depth image may be extracted as the image display region RD.

The depth camera 22 can be, for example, one that detects distance using the TOF (Time of Flight) method, or one that detects distance using the stereo method. The color camera and the depth camera need only be capable of capturing a region (angle of view) including at least the imaging region R. The angle of view captured by the color camera and the angle of view captured by the depth camera may be different. In the imaging region R where the angle of view captured by the color camera and the angle of view captured by the depth camera overlap, the pixels in the color image are preferably mapped to the pixels in the depth image. As a result, when an arbitrary pixel in the color image is identified, the pixel corresponding to that pixel in the depth image can be identified. Therefore, depth information can be acquired for any pixel in the color image.

In the example described in the above embodiment, the entire image display region RD of the screen 40 is included in the imaging region R, but the present disclosure is not limited to this. Only a portion of the image display region RD may be included in the imaging region R. In other words, only a portion of the image display region RD may be captured in the captured image 50.

In the above description, examples of the computer-readable recording medium storing the programs of the present disclosure are HDD and SSD of the storage 13, but are not limited to these examples. Other examples of the computer-readable recording medium include a flash memory, a CD-ROM, and other information storage media. Further, as a medium to provide data of the program(s) of the present disclosure via a communication line, a carrier wave can be used.

It is of course possible to change the detailed configuration and operation of each part of the detecting device 10, the imaging device 20, and the projector 30 in the above embodiments to the extent not to depart from the purpose of the present disclosure.

Although some embodiments of the present disclosure have been described in detail, the present disclosure is not limited to the disclosed embodiments but includes the scope of the present disclosure that is described in the claims and the equivalents thereof.

1. A detecting method executed by at least one processor, comprising:
acquiring a captured image that includes at least a part of an image display region on which an image is displayed and at least a part of a target object; and
detecting at least a part of the target object that is extracted in an external region as a detection target, the external region being in the captured image excluding the image display region.

2. The detecting method according to claim 1, further comprising:
identifying the image display region in the captured image,
wherein the detecting includes detecting at least a part of the target object that is extracted in the external region as the detection target, the external region being in the captured image excluding the image display region that is identified.

3. The detecting method according to claim 1, further comprising:
identifying the image display region in the captured image;
extracting the target object in the captured image; and
determining whether or not the target object that is extracted is in the external region that is in the captured image excluding the image display region,
wherein the detecting includes detecting at least a part of the target object that is determined to be in the external region as the detection target.

4. The detecting method according to claim 1, further comprising:
identifying the image display region in the captured image; and
extracting the target object in the external region that is in the captured image excluding the image display region that is identified,
wherein the detecting includes detecting at least a part of the target object that is extracted as the detection target.

5. The detecting method according to claim 1,
wherein, upon the target object including multiple target objects, the detecting includes detecting a target object having a largest area of the multiple target objects as the detection target.

6. The detecting method according to claim 1, further comprising:
upon the target object including multiple target objects, deriving an index value that represent a possibility that each of the multiple target objects is the detection target,
wherein the detecting includes detecting a target object having a largest index value of the multiple target objects as the detection target.

7. The detecting method according to claim 1, further comprising:
determining the target object extending from inside to outside of the image display region in the captured image to be outside of the image display region.

8. The detecting method according to claim 2,
wherein a component constituting the image display region has a sign at a predetermined position in the component, and
wherein the identifying includes identifying the image display region based on a position of the sign in the captured image.

9. The detecting method according to claim 2,
wherein the image displayed on the image display region includes a sign at a predetermined position in the image, and
wherein the identifying includes identifying the image display region based on a position of the sign in the captured image.

10. The detecting method according to claim 1,
wherein the detecting includes detecting at least a part of the target object as the detection target with a thresholding process based on color information of the image.

11. The detecting method according to claim 1, further comprising:
identifying the image display region based on depth information in the captured image that is a depth image including the depth information related to a distance to a measured object.

12. A detecting device comprising at least one processor that:
acquires a captured image that includes at least a part of an image display region on which an image is displayed and at least a part of a target object; and
detects at least a part of the target object that is extracted in an external region as a detection target, the external region being in the captured image excluding the image display region.

13. A non-transitory computer-readable recording medium that stores a program that causes at least one processor to:
acquire a captured image that includes at least a part of an image display region on which an image is displayed and at least a part of a target object; and
detect at least a part of the target object that is extracted in an external region as a detection target, the external region being in the captured image excluding the image display region.
